(19) United States
(12) Patent Application Publication
(10) Pub. No.: US 2007/0007830 A1
(43) Pub. Date: Jan. 11, 2007

(54) Electric machine for a transmission of a motor vehicle and device for cooling the electric machine

(76) Inventors: Matthias Reisch, Ravensburg (DE); Wolfgang Schon, Langenargen (DE)

Correspondence Address: DAVIS & BUJOLD, P.L.L.C., 112 PLEASANT STREET, CONCORD, NH, 03301, US

(21) Appl. No.: 11/480,083

(22) Filed: Jun. 30, 2006

(30) Foreign Application Priority Data
Jul. 9, 2005 (DE) 10 2005 032 204.2

(51) Int. Cl. H02K 9/00; H02K 9/20

(52) U.S. Cl. 310/54; 310/52; 180/65.1

(57) ABSTRACT

An electric machine for a transmission of a motor vehicle comprising one stator plate set (4) is connected to the transmission housing (5) and the electric machine is cooled by the transmission housing (5) and/or the transmission lubricant.

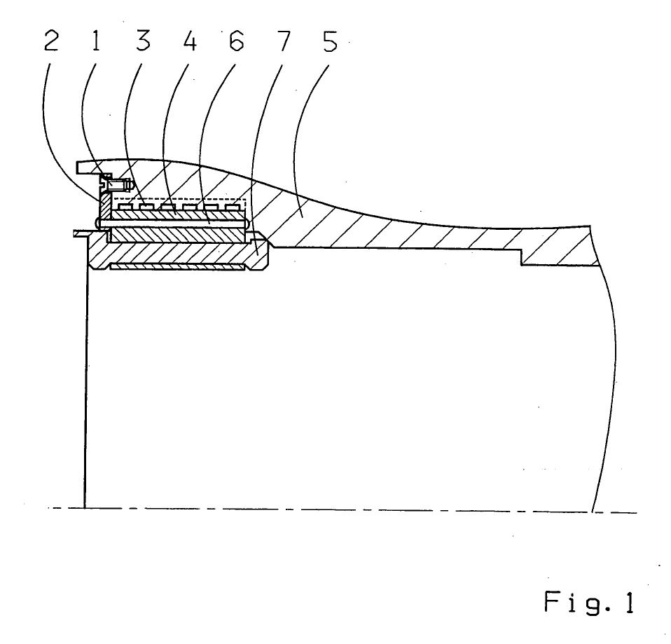

This application claims priority from German Application Serial No. 10 2005 032 204.2 filed Jul. 9, 2005.

### FIELD OF THE INVENTION

The invention concerns an electric machine for a transmission of a motor vehicle and a device for cooling the electric machine.

### BACKGROUND OF THE INVENTION

Electric machines of this kind have usually been employed in crankshafts of starter generators in hybrid vehicles.

The Applicant's DE 199 23 315 A1 discloses a driving system for a motor vehicle operable by a prime mover with one transmission unit and at least one electric machine actuatable as a motor and/or a generator. The electric machine comprises at least one stator and one rotor with active parts which, having no housing of their own, are situated within the housing of the prime mover and/or of the transmission unit axially symmetrically and/or co-axially relative to a power chain shaft or a rotating part disposed parallel therewith and forming a structural unit with parts of the prime mover and/or of the transmission unit.

From DE 44 04 791 C1 is also known a structural unit consisting of an internal combustion engine comprising a crankshaft and an electric generator/motor, the generator housing of which is firmly connected with the motor housing and the rotor thereof non-rotatably connected with the crankshaft. Here an elastically deformable torque-transmitting disc is provided, which is firmly flange mounted on the output end of the crankshaft and firmly connected with the rotor on the peripheral side. In addition, the rotor is rotatably supported in the generator housing.

To ensure an effective heat dissipation, one cooling device is needed in these electric machines.

In the prior art, those electric machines, which usually comprise an iron plate set and a current winding, are plugged or contracted in a stator carrier and cooled, via a water jacket provided in the stator carrier, with connections for intake and discharge of the water or of the coolant. The water jacket disadvantageously has to be sealed. Besides, when assembling and disassembling, care has to be taken that no water flows over the windings of the electric machine for the residues of the water are electrically conductive and produce, on the surface of the electric machine, sneak currents, which can negatively affect insulation resistances. Furthermore, considerable expenditure is needed for a duct system sealing and cooling a heat exchanger or existing cooling circuit.

This invention is based on the problem of outlining an electric machine for a transmission of a motor vehicle, whose cooling can be easily and inexpensively implemented. In addition to being outlined is a device for cooling the electric machine.

### SUMMARY OF THE INVENTION

An electric machine is accordingly proposed which is cooled by an already existing means or device of the transmission. The cooling is preferably effected by the transmission housing and/or the transmission lubricant.

The invention proposes an electric machine which can be connected to the transmission housing easily and at reasonable cost. The electric machine unit can be prefabricated and then installed in the transmission. Advantageously, no stator carrier is required, since the stator plate set is a self-supporting design. The stator plate set, for example, can be riveted, screwed and/or welded.

Within the scope of a first embodiment of the invention, cooling results by contacting the stator plate set of the electric machine with the transmission housing whereby a heat transfer can be transferred from the plate set to the housing. The dimensions of the transmission housing are such as to make the transmission capable of transporting the average accumulation of heat due to energy loss of the electric machine.

Within the scope of a special advantageous embodiment of the invention, it is proposed for electric machines having great thermal power to be eliminated on the stator by using transmission lubricant in addition to or alternatively to the cooling via the transmission housing as a cooling medium. It is provided for this purpose that by casting or machining cooling ducts in the housing through which the transmission lubricant can be passed for cooling the stator of the electric machine.

In another development, cooling ducts are provided which are formed in the stator or stator carrier.

The constructional expense for cooling of the electric machine is minimized by the inventive idea, since the cool water circuit, known from the prior art, is eliminated. Together with the lowering of cost, in addition, the advantage results that the required installation space, the same as the interface complexity, are reduced. Further reduction of the installation space needed, the same as of the expenses, is achieved by the simplest construction of the stator or of the stator plate set of the electric machine. A very good heat transfer from the electric machine to the housing or transmission lubricant is also implemented, which results in a highly possible duration of connection.

### BRIEF DESCRIPTION OF THE DRAWINGS

The invention will now be described, by way of example, with reference to the accompanying drawings in which:

The sole FIGURE is a diagrammatic representation of a preferred embodiment of the electric machine.

### DETAILED DESCRIPTION OF THE INVENTION

In the embodiment shown in the FIGURE, the electric machine is cooled by contacting a stator plate set 4 of the electric machine with a transmission housing 5 usually consisting of a good heat conductive aluminum or magnesium casting. Heat transfer from the stator plate set 4 to the transmission housing 5 is ensured. As already explained, the dimensions of the transmission housing 5 are such that it can transport the average accumulation of heat due to loss of energy of the electric machine. This performance is usually on the order of 1 kilowatt.

The fastening of the stator or of the stator plate set 4 to the transmission housing 5 is provided by the reference numeral 1. One sheet metal ring 2 is provided for fastening the stator plate set 4. In the sole FIGURE, a stator winding is designated by 7. In the embodiment shown, the stator plate set 4 is connected by rivets 6 with the sheet metal ring 2 or with the transmission housing 5.

To ensure easy disassemblage, a clearance fit is preferably provided for connecting the electric machine to the transmission housing 5. Since the transmission housing 5 usually consists of an aluminum or a magnesium alloy and the heat expansion coefficient thereof is higher than that of the soft iron stator of the electric machine, the clearance (at least when designed as an inner rotor) increases as the temperature increases which can act negatively upon the transfer of heat.

For this reason, it has been proposed, according to the invention, for electric machines having great heat power to be eliminated on the stator, to use transmission lubricant as a cooling medium, in addition to or alternatively to the a cooling, via the transmission housing 4, cooling ducts being provided for this on the transmission housing 5.

For this purpose, the cooling ducts 3 are made by casing or machining in the transmission housing 5. The transmission lubricant for cooling the stator is passed through the cooling ducts 3. According to the invention, it can be provided that the cooling ducts 3 be inserted as individual part; this is shown in the FIGURE by a dotted line. The design of the cooling ducts 3, as an individual part, results in a reasonable production cost. The same as in a better sealing of adjacent cooling ducts relative to each other over the whole temperature spectrum. The cooling ducts 3 can be made of an elastomer or a plastic material and have seals formed integral therewith or die-cast.

The heat is then transported, via the existing transmission lubricant cooling infrastructure. The cooling power is a function of the amount of lubricant and of the temperature. For the case that the electric machine is lodged in a humid space, the cooling ducts 3 do not have to be thoroughly sealed outwardly.

Any structural design, particularly any spatial arrangement of the parts of the inventive electric machine, especially of the parts for cooling the electric machine, per se or relative to each other and, insofar as technically significant, fall under the scope of protection of the instant claims without affecting the function of the electric machine, such as outlined in the claims, even if the designs have not been explicitly shown in the FIGURE or in the description.

Reference Numerals

1 fastening stator transmission housing
2 sheet metal ring for the fastening of the stator plate set
3 cooling duct
4 stator plate set
5 transmission housing
6 plate set—rivets
7 stator winding

1. Electric machine for a transmission of a motor vehicle comprising one stator plate set and device for cooling the electric machine, characterized in that the electric machine is cooled by the transmission housing (5) and/or the transmission lubricant.

2. Electric machine for a transmission of a motor vehicle and device for cooling the electric machine according to claim 1, characterized in that it can be installed in the transmission as prefabricated electric machine unit, the stator plate set (4) being designed self-supporting.

3. Electric machine for a transmission of motor vehicle and device for cooling the electric machine according to claim 1 or 2, characterized in that the electric machine is tied to the transmission housing (5) via a clearance fit.

4. Electric machine for a transmission of a motor vehicle and device for cooling the electric machine according to claim 1, 2 or 3, characterized in that one sheet metal ring (2) is provided for fastening the stator plate set (4) on the transmission housing (5).

5. Electric machine for a transmission of a motor vehicle and device for cooling the electric machine according to claim 1, 2, 3 or 4, characterized in that the electric machine is cooled by contacting of the stator plate set (4) of the electric machine with the transmission housing (5), the dimensions of the transmission housing (5) being such as to make it capable of transporting the average heat accumulated due to energy losses of the electric machine.

6. Electric machine for a transmission of a motor vehicle and device for cooling the electric machine according to any one of the preceding claims characterized in that in addition to or alternatively to the cooling via the transmission housing (5), they are cooled via the transmission lubricant by way of the cooling ducts provided on or in the transmission housing (5).

7. Electric machine for a transmission of a motor vehicle and device for cooling the electric machine according to claim 6, characterized in that in addition to or alternatively to the cooling via the transmission housing (5), they are cooled via the transmission lubricant by way of cooling ducts provided in the stator or stator carrier.

8. Electric machine for a transmission of a motor vehicle and device for cooling the electric machine according to claim 7, characterized in that the cooling ducts (3) are made in the transmission housing (5) by casting or machining.

9. Electric machine for a transmission of a motor vehicle and device for cooling the electric machine according to claim 7, characterized in that the cooling ducts (3) are fitted as individual part.

10. Electric machine for a transmission of a motor vehicle and device for cooling the electric machine according to claim 9, characterized in that the cooling ducts (3) are made of an elastomer or plastic material and have integrally formed or injected seals.
